(19) United States
(12) Patent Application Publication
(10) Pub. No.: US 2007/0246622 A1
(43) Pub. Date: Oct. 25, 2007

(54) SUCTION CUP POST SUPPORT FOR MOUNTING HARDWARE ARTICLES

(76) Inventor: LORAE A. FISTOR, SANTA ROSA, CA (US)

Correspondence Address: STAINBROOK & STAINBROOK, LLP, 412 AVIATION BOULEVARD, SUITE H, SANTA ROSA, CA, 95403, US

(21) Appl. No.: 11/739,054

(22) Filed: Apr. 23, 2007

Related U.S. Application Data
(60) Provisional application No. 60/794,248, filed on Apr. 21, 2006.

(51) Int. Cl. F16B 47/00

(52) U.S. Cl. 248/205.5

(57) ABSTRACT

A suction cup post support apparatus including a support post with upper and lower portions forming a generally hollow post structure. The lower portion of the support post includes a space for positioning a suction cup disc with a cam lever post disposed atop its dome shaped top. The cam lever post is removably inserted through a hole in a cam lever support platform integrally formed in the lower portion of the support post, and a cam lever is pivotally connected to the cam lever post to secure the suction cup support post to the suction disc and to provide means to pull a suction in the suction disc.

### CROSS REFERENCES TO RELATED APPLICATIONS

The present application claims the benefit of U.S. Provisional Patent Application Ser. No. 60/794,248, filed Apr. 21, 2006, (Apr. 21, 2006).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to an article holder, and more particularly to a suction cup device adapted for providing a post upon which to selectively and removably attach articles.

2. Discussion of Related Art Including Information Disclosed Under 37 CFR 1.97, 1.98

Designs and structure for support apparatus of mounting brackets for holding articles are too numerous even to list, let alone discuss in any detail. When the support or mounting bracket is permanent, the common principal disadvantage is the restricted access to the mounting surface, whether it be a generally vertical mounting surface, such as a wall, or a generally horizontal surface, such as a table, bench, or counter top. When the support or mounting bracket is temporary, the common principal disadvantage is lack of structural integrity and strength.

The use of suction cups in support systems is well known. Indeed, as early as 1963, U.S. Pat. No. 3,082,988 to Holden shows a suction cup mounting apparatus for kitchen appliance, specifically, a food grinder. The mounting apparatus is integrated into the food grinder and provides means to removably mount the grinder on a counter top for periodic or seasonal use. This obviates the need to drill the counter top or to have a bulky appliance always present and generally in the way of other kitchen operations.

Improved suction cup mounting systems have been devised as recently as 2005. Notably, U.S. Pat. No. 6,913,232 to Richter, teaches a suction cup article support system having housing with a base defining a cavity, a suction disc supported in the cavity, and a mechanism for actuating the suction disc so as to create a vacuum between the suction disc and a smooth support surface. At the other end, the housing includes an article support plate with engagement claws for engaging a particular article.

Earlier improvements include another patent to Richter, U.S. Pat. No. 6,749,160, and U.S. Pat. No. 6,234,435, to Yeh, each of which disclose a suction disc mounting arrangement for supporting objects on smooth surfaces. The devices include a cone-shaped base and a suction disk disposed in the base. The base includes a sleeve and the suction disc includes a post inserted into the sleeve. An actuation member is disposed in the sleeve and engages the post of the suction member to pull a vacuum under the suction disc and secure the base to a surface and the sleeve to the base.

U.S. Pat. No. 5,779,205 to Ching shows a an extensible windshield portable phone holder that utilizes a sucking device for firmly attaching the phone holder onto a windshield.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Although the references provide a foundation for suction cup support apparatus, none shows apparatus particularly well suited for supporting hardware articles in kitchens or other environments in regular need of cleaning. This is because the support housing and suction cup apparatus are not easily separated for through cleaning. Accordingly, there remains a need for a hardware article mounting apparatus comprising easily manipulated parts that can be assembled and disassembled with relative ease, and adapted for cleaning in a convention dishwashing machine.

### BRIEF SUMMARY OF THE INVENTION

The present invention is suction cup post support for mounting hardware articles.

It is a first and principal object of the present invention to provide a new and improved suction cup support apparatus that is particularly well adapted for use in mounting kitchen and bathroom articles, such as soap dishes, lotion dispensers, paper cup dispensers, paper towel holders, towel racks, and the like.

It is another object of the present invention to provide a new and improved suction cup support post that provides means for rapid and easy removal of the installed article for cleaning or for replacement with another hardware article.

A further object or feature of the present invention is a new and improved suction cup mounting apparatus that facilitates thorough cleaning of both the apparatus and the surface upon which the apparatus is typically mounted.

An even further object of the present invention is to provide a novel suction cup mounting post that entirely eliminates the need to install permanent fasteners in the mounting surface, and therefor permits easy and non-damaging repositioning of the apparatus.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a front perspective view showing the assembled suction cup post support for mounting hardware articles of the present invention;

FIG. 2 is an exploded perspective view showing the structural and operational elements comprising the inventive apparatus;

FIG. 3 is an upper perspective view showing the suction cup and suction actuating lever assembly;

FIG. 4 shows a first exemplary article of hardware suited for mounting on the post portion of the inventive apparatus; and

FIG. 5 shows a second exemplary article of hardware that may be mounted on the post portion of the inventive apparatus.

### DETAILED DESCRIPTION OF THE INVENTION

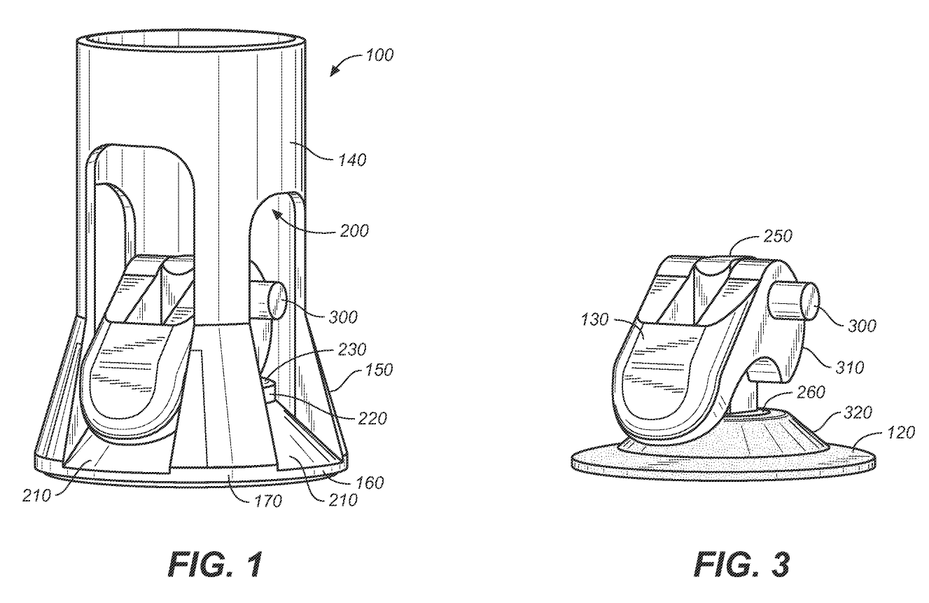

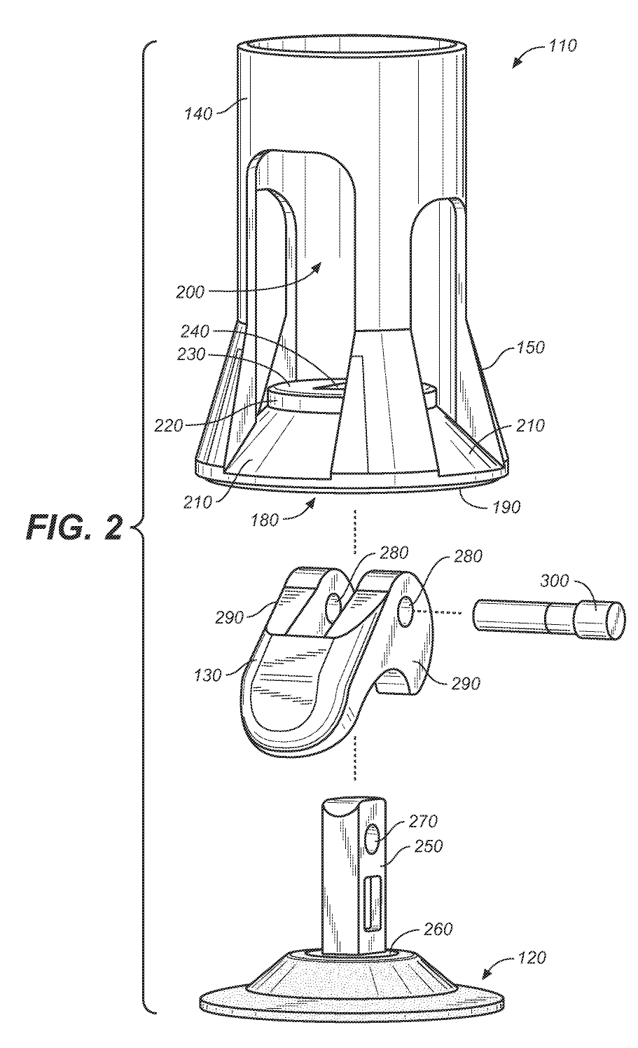

Referring to FIGS. 1 through 5, wherein like reference numerals refer to like components in the various views, there is illustrated therein a new and improved suction cup post support for mounting hardware articles, generally denominated 100 herein.

FIGS. 1-3 illustrate the preferred embodiment of the suction cup post support of the present invention, showing that it comprises three principal elements: a support post 110, a suction disc 120, and a cam lever 130. The support post includes an upper cylindrical portion 140 and a lower truncated conical portion 150 which terminates at its lower end 160 in a circumferential side 170 which is generally normal to any flat surface on which the apparatus is mounted. The lower conical portion includes a dome-shaped opening 180 in its underside 190 providing a space in which the suction cup disc 120 (or suction disc) is disposed. The upper cylindrical portion 140 and the lower truncated conical portion 150 are each at least partially open and combine to form a hollow interior 200. A dome integrally formed in the lower conical portion has angled sides 210 capped by a stage 220 having a planar upper platform 230, and an opening 240 through which a cam lever post 250 may be inserted. The cam lever post is welded to, or otherwise integral with, the upper surface 260 of the suction disc.

The cam lever post 250 includes a through hole 270 which is aligned with spaced apart through holes 280 in corresponding spaced apart cam lever arms 290, such that when the cam lever post is inserted through opening 240, a pivot pin 300 may be inserted through the aligned holes to secure the suction disc in the dome-shaped space of the lower truncated conical portion 150 of the support post 110. The cam surfaces 310 are contoured so that when cam lever 130 is actuated and moved downwardly into a locked position (FIG. 1), the cam lever post 250 is pulled upwardly, thus pull the deformable portion 320 of suction disc 120 upwardly to create an attachment suction, all in a manner well known in the art.

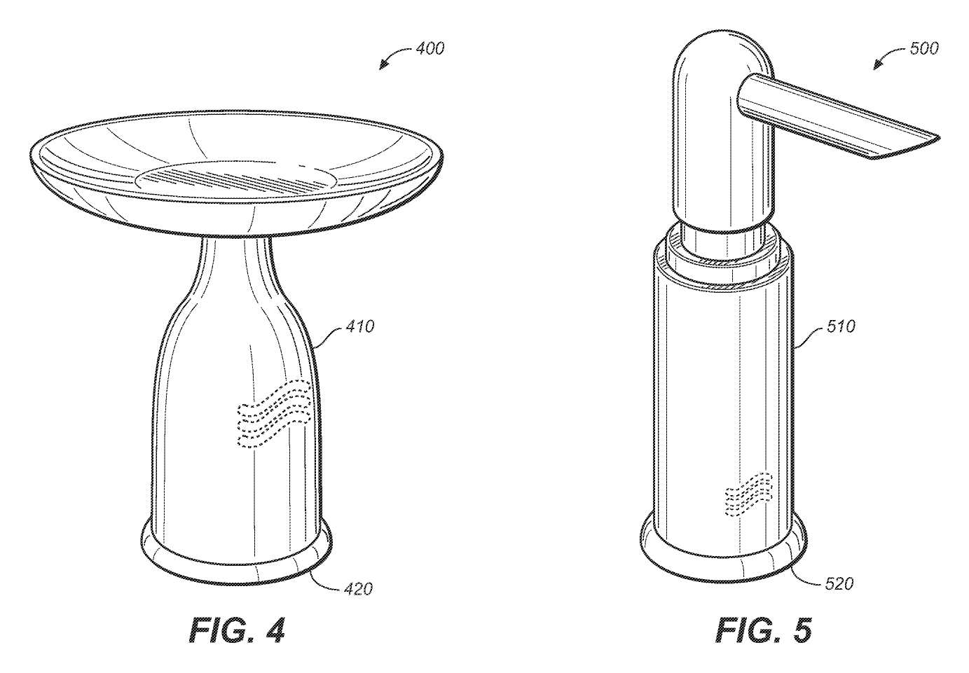

When so installed on a surface, the support post provides a structure on which articles of hardware may be removably mounted. Examples of such articles are shown in FIGS. 4 and 5. As will be appreciated, the soap dish 400 (FIG. 4) and the soap dispenser 500 (FIG. 5), each include lower portions or bottoms 410, 510 with an opening (not shown) having an interior side with a dimension or diameter tightly conforming to the size and shape of the circumferential side 170 of the lower truncated conical portion 150. Thus, the article is simply mounted on the secured support post and tightly disposed over the circumferential side so that the bottom edge 420, 520, of the respective articles is essentially flush with the surface on this the apparatus is removably installed. Accordingly, when mounted on the inventive support post, the article and support post combination appears substantially as shown, with the support post entirely covered and out of sight. Thus, the mechanical elements of the apparatus do not detract from the aesthetic or ornamental elements of the article of hardware. Furthermore, because the fit of the article of hardware is essentially a friction fit, the article may be easily removed simply by pulling it upwardly and off the post. This facilitates easy cleaning of the hardware article, and provides ready access to the cam lever so that the suction cup may be deactivated and the support post removed from the surface on which it is mounted. The surface can then be cleaned and the space employed for other uses, or the support post and hardware article may be returned to the surface with easy repositioning as desired.

As will be readily appreciated, numerous kinds of hardware articles could be adapted for installation over the support post of the present invention, and the suction cup apparatus for securing the support post could be installed on any of a number of suitable surfaces in a wide variety of places, indoors and outdoors, including tables, benches, counter tops, portable barbeque grills, food cart counters, and the like. Thus the inventive apparatus provides means for taking and securing articles in places where it would be unusual, but nonetheless desirable, to have such an article. For instance, it would be desirable to mount a soap dispenser on a picnic table at a picnic site so that diners could clean up after a messy meal. The apparatus of the present invention provides an elegant solution to meet such a need.

Furthermore, many articles are more easily used when secured to a surface, and surfaces are more easily cleaned when impediments are removed from the surface. Accordingly, the present invention includes the advantage of being selectively removable from any surface on which it is installed. In decorating and equipping a kitchen, for instance, this provides considerable flexibility in providing such things as soap dispensers, soap dishes, lotion dispensers, paper cup dispensers, condiment dispensers, and the like.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. As an example of an obvious modification, one contemplated in the present disclosure, the support post configuration or shape could be any of a number of suitable shapes other than cylindrical and thus adapted for an article having a complementarity shaped opening, hole, or recess. Posts could easily a cross sectional shape of square, rectangular, oval, triangular, polygonal of virtually any kind, and so forth. As such variations are virtually unlimited, they are not illustrated other than by way of mention in this textual description. However, the above description and illustrations should not be construed as limiting the scope of the invention, which is defined by the appended claims.

What is claimed as invention is:

1. A suction cup post support apparatus, comprising:
a support post having an upper portion and a lower portion, said lower portion having an underside with an opening and a lower end which terminates in a circumferential side, wherein said upper portion and said lower portion are at least partially open and combine to form a hollow interior in said support post;
cam lever support structure disposed in said lower portion and having an opening;
a suction cup disc disposed in the opening in said underside of said lower portion of said support post, said suction disc having a cam lever post disposed on its upper surface and removably inserted through the opening in said cam lever support structure; and
a cam lever pivotally connected to said cam lever post with a pivot pin.

2. The apparatus of claim 1, wherein said upper portion of said support post is generally cylindrical.

3. The apparatus of claim 1, wherein said lower portion of said support post is generally a truncated cone and said opening in said lower portion is dome-shaped.

4. The apparatus of claim 1, wherein said cam lever support structure includes a cam lever support platform having a hole substantially in its center through which said cam lever post may be removably inserted.

5. The apparatus of claim 1, wherein said cam lever support structure is integrally formed in said lower portion of said support post and includes angled sides capped by a stage having a planar upper platform with an opening through which said cam lever post may be removably inserted.

6. The apparatus of claim 1, wherein said circumferential side of said lower portion is generally normal to any flat surface on which said apparatus is mounted.

7. The apparatus of claim 1, wherein said cam lever includes a through hole, and said cam lever post includes a through hole aligned with spaced apart through holes in spaced-apart and said cam lever includes cam lever arms having through holes, such that when said cam lever post is inserted through the opening in said cam lever support structure, said pivot pin may be removably inserted through the aligned holes to secure said suction cup disc.

8. The apparatus of claim 8, wherein said lower portion is a truncated cone and the opening in said lower portion of said support post is a dome-shaped space.

9. The apparatus of claim 1, wherein said cam lever includes cam surfaces contoured so that when said cam lever is actuated and moved downwardly into a locked position, said cam lever post is pulled upwardly and pulls said suction cup disc upwardly to create an attachment suction.

10. The apparatus of claim 1, wherein said lower portion includes angled sides that terminate in said circumferential side of said lower portion and wherein said circumferential side is generally normal to any flat surface on which said apparatus is mounted, such that an article of hardware having a cylindrical opening may be placed over said support post to create a friction fit with said circumferential side.

11. An article of hardware and suction cup support assembly, comprising:
a support post having an upper portion and a lower portion, said lower portion having an underside with an opening and a lower end which terminates in a circumferential side, wherein said upper portion and said lower portion are at least partially open and combine to form a hollow interior in said support post;
cam lever support structure disposed in said lower portion and having an opening;
a suction cup disc disposed in the opening in said underside of said lower portion of said support post, said suction disc having a cam lever post disposed on its upper surface and removably inserted through the opening in said cam lever support structure;
a cam lever pivotally connected to said cam lever post with a pivot pin; and
a hardware article mounted over said support post.

12. The apparatus of claim 11, wherein said lower portion includes angled sides that terminate in said circumferential side of said lower portion and wherein said circumferential side is generally normal to any flat surface on which said apparatus is mounted, and wherein said article of kitchen hardware includes a bottom and a mounting hole bored into said bottom, said mounting hole having an interior circumferential dimension substantially the same as the outer circumference of said circumferential side, such that when said article of kitchen hardware is placed over said support post a friction fit is established with said circumferential side, and said bottom of said hardware article is generally approximated to the surface on which said support post is attached.

13. The apparatus of claim 11, wherein said hardware article is selected from the group consisting of soap dish, paper cup dispenser, lotion dispenser, towel rack, and paper towel holder.

14. The apparatus of claim 11, wherein said support post is substantially cylindrical in shape.
